(19) United States
(12) Patent Application Publication
(10) Pub. No.: US 2019/0160778 A1
(43) Pub. Date: May 30, 2019

(54) NAP PRODUCT WITH UNIDIRECTIONALLY INCREASED STRENGTH FOR PRODUCING CARBON FIBER REINFORCED PLASTIC (CFRP) COMPONENTS

(71) Applicant: AUTEFA SOLUTIONS GERMANY GMBH, Friedberg (DE)

(72) Inventor: Anton MOOSHAMMER, Aschersleben (DE)

(21) Appl. No.: 16/320,751

(22) PCT Filed: Jul. 26, 2017
(86) PCT No.: PCT/EP2017/068887

§ 371 Date: Jan. 25, 2019

(30) Foreign Application Priority Data
Jul. 26, 2016 (DE) 20 2016 104 070.1

(51) Int. Cl. B32B 5/12; B29C 70/20; B29C 70/30; B32B 5/26; B32B 5/02; D04H 1/4374; D04H 1/4209; D04H 1/4342; D04H 3/002

(52) U.S. Cl. CPC B32B 5/12; B29C 70/20; B29C 70/30; B32B 5/26; D04H 3/002; D04H 1/4374; D04H 1/4209; D04H 1/4342; B32B 5/022

(57) ABSTRACT

A semi-finished product includes a partly reinforced assembly (11) of a nap layer (12, 13, 14, 15) made of a non-woven fiber nap (16) and an additional fiber layer (21, 22), stacked face-to-face. The nap layer includes carbon fibers, aramid fibers, or mineral fibers, such as glass or basalt fibers, having a preferred orientation (VR). The assembly is produced by a layering process. The nap layer and the fiber layer are free of additional macro proppants. The additional fiber layer includes a web thread group (23, 24) of individual adjacent threads. The fiber layer includes carbon fibers, aramid fibers, or mineral fibers, such as glass or basalt fibers and has an exclusive fiber orientation (FA). The nap product is partly reinforced by local connection points between the fibers of the different layers. The semi-finished product has a high directional strength and a high maximum drapability at the same time.

### CROSS REFERENCE TO RELATED APPLICATIONS

This application is a United States National Phase Application of International Application PCT/EP2017/068887, filed Jul. 26, 2017, and claims the benefit of priority under 35 U.S.C. § 119 of German Application 20 2016 104 070.1, filed Jul. 26, 2016, the entire contents of which are incorporated herein by reference.

### TECHNICAL FIELD

The present invention pertains to a nap product, especially a technical nap product for use as a semi-finished product for producing fiber-reinforced composites, especially CFRP components. The present invention further pertains to a process for producing the nap product as well as to a corresponding production plant.

### TECHNICAL BACKGROUND

The use of nap products comprising one or more nap layers to produce fiber-reinforced composites is known in practice. The prior-art nap products have a markedly better drapability (3D deformability) than likewise prior-art fiber fabrics and fiber scrims. This is due especially to the fact that the fibers contained in a fiber nap have only a comparatively small number of connection points between the individual fibers. A nap product can thus be draped, i.e., it can be adapted to any desired three-dimensional shape with deviation from the flat extension occurring in the original product, to a markedly greater extent with a reduced tendency to tear and without creasing. Further, nap products offer the advantage that shorter fibers and optionally recycled fibers can be used to produce them. A large portion of the waste generated during the production of fiber-reinforced composites or the total amount of the waste can thus be reused.

The nap products known hitherto for producing fiber-reinforced composites do not have optimal strength properties for the production processes commonly used in practice.

The fibers contained in a fiber nap may have a preferred orientation. However, a rather appreciable percentage of the fibers in the fiber nap will have a tangled orientation and thus deviate from the preferred orientation, so that the directional strength in the direction of the preferred orientation is only slightly higher than the strength in the direction at right angles thereto. Markedly high directional strengths are at times desirable for producing components from fiber-reinforced composites.

WO 2012/059538 A1 discloses a nonwoven, which can be used as a semi-finished product for producing fiber-reinforced composites, and a corresponding production process. The nonwoven is produced from a textile planar fabric, which comprises one or more nap layers and a reinforcing grid. In WO 2012/059538 A1 and according to the common definition adopted in the technical area, a nap layer is a loose layer of individual fibers, which are not strengthened and are intertwined with one another in a tangled form. By contrast, a nonwoven or a nonwoven material is a nap layer strengthened, for example, by needling. The reinforcing grid comprises at least the structural components “braces” and “crossing points.” The semi-finished product is formed by:

Producing a nap layer (unstrengthened) and laying the nap layer as a panel; application of the reinforcing grid to the nap layer; strengthening of the layers stacked one upon the other, for example, by needling.

The semi-finished product produced according to WO 2012/059538 A1 has a somewhat improved drapability compared to pure scrims. However, the semi-finished product obligatorily comprises crossing points between the fibers of the reinforcing grid, which lead to locally inhomogeneous surface properties. For example, a locally different ability to take up a matrix material will result, and the crossing points lead to a checkerboard pattern on the surface of the component to be produced from the semi-finished product.

DE 34 11 074 A1 discloses a process and a device for forming a fibrous nonwoven. Individual fibers from a fiber stream being fed are laid consecutively on a conveyor belt by one or more changeable dispensing devices in order to form the fibrous nonwoven. Furthermore, a prefabricated planar fabric is fed on the conveyor belt, and the fibrous nonwoven is then formed on this by laying the fibers.

DE 102 05 829 A1 discloses a layered material for building products and a corresponding production process. An upper layer and a lower layer are formed from a nonwoven material. A support structure consisting of at least two single threads is provided between them, and one of the threads is laid in an oscillating manner. When a plurality of single threads are laid, these are arranged such that they at least partly cross over each other. The upper layer, the lower layer and the support structure arranged between them are connected to one another, e.g., by bonding, needling, hydroentanglement or thermobonding. The nonwoven materials for the upper layer and the lower layer are produced by a spunbonded nonwoven producing device and/or a meltblown nonwoven producing device and they accordingly contain filaments. Spinning and meltblown processes are not suitable for handling the usual staple fibers, which are contained as load-bearing component in a carded fiber nap and are used for a fiber-reinforced composite.

DE 197 15 740 A1 discloses a process for producing nonwovens for textile floor coverings, especially carpets. A fiber nap is laid on an already strengthened carrier nonwoven or carrier fabric from a shaking box with outlet-side rollers. The composite is subsequently strengthened once again in a needling machine.

DE 10 2009 019 175 A1 describes a process for producing a reinforcing structure from a fiber-like material, which has at least one nonwoven support layer, which consists of recycled fiber material, which is obtained, for example, from cutting wastes. The reinforcing structure is formed by first preparing the recycled fibers. This is followed by a mechanical nonwoven formation. This comprises the operations of carding, during which a fiber orientation is generated, and fixation or stabilization by needling. A strengthened nonwoven or a nonwoven material from recycled fibers is thus produced. In addition to this separately strengthened nonwoven layer, the reinforcing structure may have a layer of unidirectionally oriented reinforcing fibers, and these two layers are interspersed with a secondary structure, which consists of at least one thread, and the two layers are connected to one another, for example, by the layers with the thread being sewn or by the layers being interspersed with a fabric structure or with a knitted fabric.

DE 10 2011 000 722 A1 discloses a process for producing a fibrous semi-finished product, in which a carrier material is provided, on which oriented fibers are laid and are distributed flatly. The carrier material may be a nonwoven, i.e., an already strengthened nap product. The carrier material with the fibers applied to it is fed to a press section with a calendar in order to permanently connect the fiber elements to the carrier material.

A process for producing a plate-like semi-finished product from a fiber composite is known from WO 2011/101094 A1. Fiber naps with oriented carbon fibers are combined in substance with reinforcing structures consisting of filaments in a layer assembly. The layer assembly is heated, so that a thermoplastic plastic component contained in the layer assembly softens or melts. The layer assembly is compacted and strengthened while cooling under pressure or without additional mechanical pressing pressure.

### SUMMARY OF THE INVENTION

An objective of the present invention is to show an improved production technology for a technical nap product as a flat or panel-shaped semi-finished product for producing fiber-reinforced composites. The production technology comprises a production process, a production plant for carrying out the production process as well as the semi-finished product produced.

The semi-finished product according to the present disclosure is a nap product with a high drapability and with a high unidirectional strength. It further has a good suitability for cutting.

The semi-finished product or the nap product comprises an assembly of at least one nap layer made of a nonwoven fiber nap and at least one additional fiber layer, which assembly is stacked or layered face to face. The additional fiber layer is stacked or layered to the at least one nap layer and is formed by a panel-shaped thread group. This thread group has an exclusive fiber orientation and is formed from individual threads arranged next to each other. The additional fiber layer is thus free from crossing points and has, like the at least one nap layer, homogeneous properties over its surface. The stacked assembly is partly strengthened as a whole, so that the semi-finished product forms a thread-reinforced nonwoven material. Preferentially, exclusively the stacked assembly in its entirety is partly strengthened, i.e., neither the at least one nap layer present nor the at least one fiber layer present is subjected to a separate partial strengthening operation. It is ensured in this manner that the local connection points generated with the partial strengthening are distributed essentially homogeneously over the surface of the semi-finished product and they are distributed essentially homogeneously over the cross section of the stacked assembly. Essentially homogeneous distribution of the free path lengths of the fibers present between the connection points is achieved as a result over the semi-finished product (flatly and over the cross section), so that uniform drapability of the semi-finished product is facilitated. The uniformity of the drapability is, in addition to the degree of drapability (deformability), a special advantage, which is obtained by the semi-finished product according to the present disclosure. The semi-finished product thus offers an especially good processability for the production of components from fiber-reinforced plastics, especially with the formation of greatly curved shapes.

A fiber nap is a mat-shaped or panel-shaped blend of individual fibers or fiber flocks, and, depending on the manner in which the fiber nap was produced, a preferred orientation of the fibers, along which a higher percentage of the fibers or fiber parts is oriented, may be present. The fiber nap is a mechanically formed fiber nap from staple fibers within the framework of the present disclosure. It is especially a carded nap, which consists predominantly or completely of matrix staple fibers.

Due to the exclusive fiber orientation of the thread group, the strength of the nap product as a whole is unidirectionally increased compared to the strength of the fiber nap, so that the strength of a composite to be produced can also be increased unidirectionally with the use of the nap product. The nap layer and the fiber layer have high drapability each in themselves, because there are only weak connection forces at right angles to the preferred orientation or at right angles to the fiber orientation between the fibers present in the nap layer as well as between the threads present in the nap layer as well as between the threads present in the fiber layer.

The nap layer and the additional fiber layer have a homogeneous structure over the surface, i.e., they are free from additional macro support structures or macro support elements, such as seams or stitches. In particular, the thread group may be free from thread crossings, adhering grids, support seams or similar seams or stitches acting over the surface. In other words, the thread group may preferably consist exclusively of threads laid next to each other.

Both the nap layer and the fiber layer can be adapted with high inner mobility to three-dimensional shapes, without a crease or a preferred incipient fissure site being produced from the (macro) structure of the nap layer or of the fiber layer. The strength properties as well as the drapability (deformation properties) of both the nap layer and the additional fiber layer can therefore be homogeneous over the surface.

Based on the homogeneous structure of the nap layer and of the additional fiber layer over the surface, a homogeneous ability to absorb a matrix-forming composite can be obtained, which leads to a lower overall weight when a component is produced from a fiber-reinforced composite. Furthermore, a homogeneous appearance of the composite to be produced over the surface can be obtained by a homogeneous structure of the nap product, which structure is free from macro support elements. An undesired checkerboard pattern or web pattern, which is at times undesired, as well as drawbacks associated therewith for the ability of being lacquered are avoided, regardless of whether a nap layer or an additional fiber layer is provided as the outer edge layer of the nap product.

The assembly of the nap layer and fiber layer, which assembly is stacked face to face, and which is formed exclusively by layering, obtains maintains the above-mentioned properties for the nap product formed according to the present disclosure. The partial strengthening of the assembly stacked face to face may likewise be carried out homogeneously over the surface, so that no negative impact on the above-mentioned advantages is to be feared.

While the threads in the thread group contribute the advantage of a unidirectional increase in strength of the nap product, at least one support function, which prevents easy tearing of the threads contained in the thread group at right angles to the fiber orientation or the thread direction, is generated for the threads from the nap layer. The nap product formed from the at least one nap layer and the at least one additional fiber layer thus has equivalent or increased directional strengths and at the same time improved ease of handling compared to similar semi-finished products made of a fabric or a supported thread scrim.

In particular, the fiber layer does away with a support structure, as this is present in scrims, knit fabrics and other usual strengthening structures. The transverse strength of the individual threads in the fiber layer is achieved in the semi-finished product only by the partial strengthening with an adjacent nap layer.

The nap product according to the present disclosure may comprise one, two or more nap layers as well as one, two or more additional fiber layers, and these layers may have each an identical configuration or different configurations. The desired properties and especially the directional strengths of the nap product can be set largely freely by selecting the number and the type of the respective layers. Further, identical or different fibers or fiber blends may be used in the individual layers.

At least one layer of the nap product, i.e., at least one nap layer or at least one additional fiber layer, is formed predominantly or exclusively from a fiber material that acts as the load-bearing fiber (load-bearing fibers for short) in the fiber composite to be produced. This may be especially a carbon fiber, aramid fiber or a mineral fiber, such as a glass fiber or a basalt fiber. Further, blends of the aforementioned fibers are possible. The overall percentage of the load-bearing fibers in the nap product is especially preferably 30% to 90%, and the different layers may have different inner percentages of the load-bearing fiber.

According to a first aspect, a nap layer and at least one fiber layer may be contained in the nap product, the nap layer having a preferred orientation of the fibers contained in the fiber nap and the exclusive fiber orientation in the at least one additional fiber layer is oriented essentially parallel to this preferred orientation. Due to the parallelism between the preferred orientation and the exclusive fiber orientation, a maximum of unidirectional strength in this parallel direction is combined with a minimum of unidirectional strength in the transverse direction. The strength in the parallel direction may be several times the strength in the transverse direction.

According to a second aspect, the nap product may contain a nap layer with a preferred orientation and an additional fiber layer with an exclusive fiber orientation, the preferred orientation and the exclusive fiber orientation being oriented essentially at right angles to one another. A nap product produced in this manner has an especially high strength in the direction of the exclusive fiber orientation as well as a second, unidirectionally increased strength in the preferred orientation, i.e., at right angles to the exclusive fiber orientation. The strength may, by contrast, be lower in all other directions.

Furthermore, two or more nap layers, which have a preferred orientation each, may be provided in the assembly stacked face to face, these preferred orientations being directed at right angles to one another. Such an assembly is obtained especially when a first nap layer is produced by longitudinal plaiting or longitudinal laying and a second nap layer by crossplaiting or crosslaying.

A plurality of layers of fiber semi-finished products are laid, as a rule, in a mold during the production of fiber-reinforced composites. An additive forming the matrix of the composite is added. The structure thus formed from semi-finished product layers and additive is subsequently or intermittently compressed and cured, especially by introducing heat and pressing.

A nap product according to the present disclosure, which comprises a plurality of layers, can have increased drapability and good permeability for an additive forming the matrix despite the increased thickness compared to single-layer fabrics or fiber scrims and despite the increased weight per unit area. Further, the assembly stacked face to face in the state of the semi-finished product may already have a desired directional distribution of the strength, which is otherwise obtained only in the more completely processed state, namely, due to the superimposition of layers of semi-finished product, which takes place during the production of the component. By applying only one layer of semi-finished product from the nap product according to the present disclosure, a structural formation can thus be created for a component to be produced, which formation could only be achieved by the sequential application of a plurality of layers of semi-finished product when fabrics or scrims are used. Due to the use of the nap product according to the present disclosure, the number of semi-finished product layering operations for producing fiber-reinforced components can consequently be reduced, which leads to advantages in terms of cost and time.

A production process for producing a nap product according to the present disclosure comprises at least the following steps, which can be carried out in the order indicated or in any other order:

An assembly of at least one nap layer consisting of a nonwoven fiber nap and at least one additional fiber layer, which said assembly is stacked face to face, is formed. The nap layer is laid as a panel-shaped nap layer on a conveyor. At least one panel-shaped thread group is laid to form at least one additional fiber layer above and/or under the nap layer, especially on the same conveyor.

The assembly of the nap product, which assembly is stacked face to face, is partly strengthened. The partial strengthening may be carried out by any desired strengthening device. The partial strengthening is brought about by producing local connection points between the fibers of the different layers in the assembly stacked face to face, i.e., between the fibers of the one or more nap layers and the one or more additional fiber layers. Such local connection points may be produced especially by thermobonding, by needling or by hydroentanglement. As an alternative, any other processes may be used for the partial strengthening of the assembly of the nap product, which assembly is stacked face to face. The partial strengthening is preferably carried out such that the local connection points are distributed homogeneously relative to the surface of the stacked assembly.

The extent of the partial strengthening, i.e., the type or the number of the connection points produced per unit area, may preferably be able to be set. Due to the partial strengthening, the inner holding together of the nap product is increased, so that the nap product can be handled more easily. In particular, the supporting effect of a nap layer for an adjacent thread group can be increased. However, the partly strengthened semi-finished product maintains its drapability, because the connection points are present only locally, so that there still remains a free mobility of the fibers and threads.

A production plant for producing a nap product according to the present disclosure comprises at least one conveyor and a nap laying apparatus for laying a fiber nap on the conveyor. A nap layer is created in the assembly of the nap product stacked face to face by laying the fiber nap. The nap layer is especially a nap panel extending in the pull-off direction of the conveyor. The production plant further comprises a thread group layer, which is configured to stack a thread group onto the nap layer. Provisions may be made in this connection, in particular, for the thread group layer to lay the thread group on the same conveyor on which the above-mentioned nap layer is also laid. The laid thread group may thus likewise form a fiber layer extending in a panel-shaped manner in the assembly stacked face to face.

The present invention is schematically shown in the drawings as an example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an oblique view of the assembly of nap product according to the present disclosure, which assembly is stacked face to face;

FIG. 2 is an oblique view of a first embodiment variant for laying a nap layer and an additional fiber layer on a conveyor;

FIG. 3 is a cross-sectional view of the assembly stacked face to face, which was produced according to the process according to FIG. 2;

FIG. 4 is an oblique view of a second embodiment variant for laying a nap layer and another fiber layer on a conveyor;

FIG. 5 is a cross-sectional view of the assembly stacked face to face, which was produced according to the process according to FIG. 4;

FIG. 6 is a first preferred embodiment variant of a production plant according to the present disclosure; and

FIG. 7 is a second preferred embodiment of the production plant.

### DESCRIPTION OF PREFERRED EMBODIMENTS

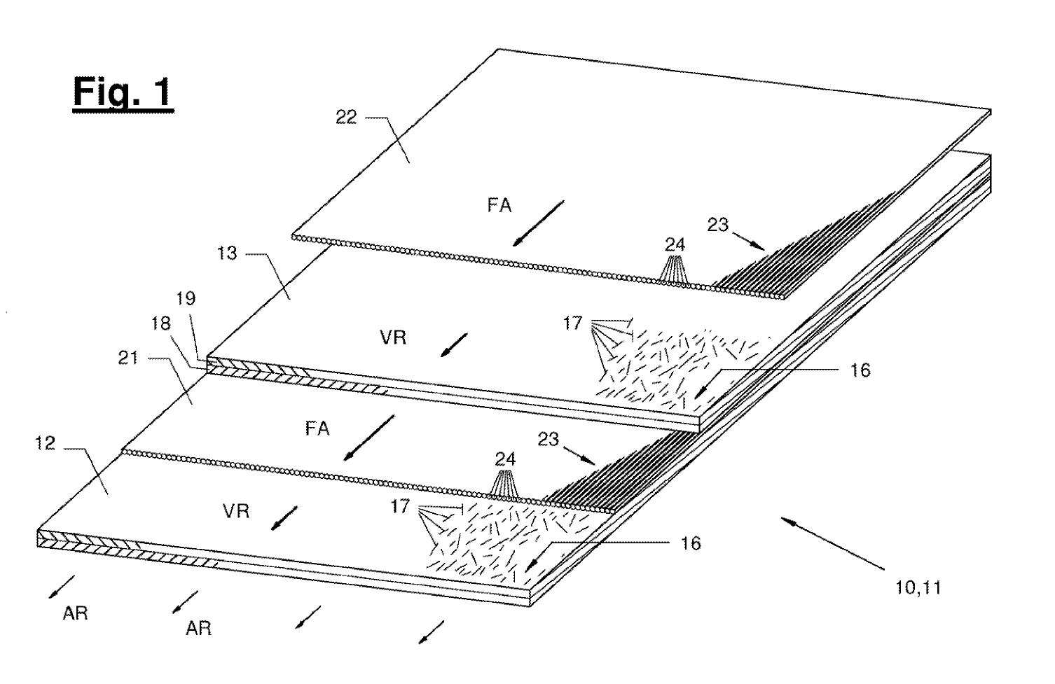

Referring to the drawings, an exemplary embodiment of the nap product according to the present disclosure is shown in FIG. 1. The nap product (10) is formed by an assembly (11) stacked face to face. At least one nap layer (12, 13) and at least one additional fiber layer (21, 22) are contained in the assembly (11). The at least one nap layer (12, 13) and the at least one additional fiber layer (21, 22) are preferably panel-shaped and extend in a pull-off direction (AR), which is predefined, for example, by the run direction of a conveyor.

In the example according to FIG. 1, both the lower or first nap layer (12) and the upper or second nap layer (13) have a preferred orientation (VR), in which a predominant portion of the fibers (17) contained in the fiber nap (16) are directed. Such a preferred orientation (VR) can be produced, for example, during the production of the fiber nap in a card (45), which will be explained in detail below.

The fiber nap (16) may be laid on a conveyor (30) directly and in single layer to form a nap layer (12, 13). As an alternative, the fiber nap (16) may be plaited in two or more layers to form a nap layer (12, 13). Various embodiment variants for the laying by plaiting of a fiber nap will be explained farther below.

The thread group (23) laid to form an additional fiber layer (21, 22) is formed by a plurality of threads, especially yarn threads (24), which are located in a common plane or panel and are arranged at least next to one another. The threads, especially yarn threads (24), which are contained in a thread group (23), are nonwoven and uncrossed individual threads.

The exclusive fiber orientation (FA) is parallel to the extension of the threads (24) in the thread group (23). The number of threads, especially yarn threads (24), which are contained in a thread group (23), as well as the lateral distance between them, may be predefined in a specific manner in order to obtain certain properties of the nap product. The more yarn threads (24) are contained in an additional fiber layer (21, 22) and the smaller the distance between adjacent yarn threads (24), the higher will be the degree of the unidirectional strength increase in the nap product along the exclusive fiber orientation (FA) and vice versa.

Any desired type of yarn, for example, staple fiber yarns, core yarns or filament yarns, may be used to form the yarn threads (24). As an alternative, rovings or spread rovings may be laid to form a thread group. The threads of the roving are to be sorted and fanned out in this case such that these are arranged exclusively next to each other.

Staple fiber yarns or core yarns may contain recycled fibers, especially recycled carbon fibers or carbon fibers, recycled aramid fibers or recycled glass fibers. A filament yarn may consist of a monofilament or of a small number of, e.g., twisted filaments. A filament is a continuous fiber. A roving is a strand or bundle of unconnected filaments.

The material of the nap layer and/or of the at least one additional fiber layer may be of any type. In particular, all the fiber materials known for the production of fiber-reinforced composites may be used. These include, in particular, load-bearing fibers such as carbon fibers, aramid fibers or mineral fibers, such as glass fibers or basalt fibers. The fibers of a nap layer may also be formed partly or entirely by recycled fibers.

A nap layer or each nap layer and/or one or each additional fiber layer may consist predominantly or completely of one of the above-mentioned fiber materials. As an alternative, one or each nap layer as well one or each additional fiber layer may consist of a blend of two or more of the aforementioned fiber materials.

According to another aspect, fibers of a material that acts as a matrix-forming component (matrix fibers for short) may be contained in one or more nap layers as well as in one or more additional fiber layers. In particular, fibers of a meltable plastic (thermoplastic plastic) may be contained. Such a portion of fibers may be used, for example, for the partial strengthening of the assembly (11) of the nap product (10), which assembly is stacked face to face, during the thermobonding, because isolated bonding points are formed between the fibers of the different layers (12, 13, 21, 22) due to local melting. As an alternative or in addition, local connection points may also be produced with each of the material combinations by a local entanglement of individual fibers of the different layers of the nap product, especially by needling or hydroentanglement. Furthermore, the percentage of the fibers in the nap layers and/or in the fiber layers, which as the matrix-forming component (matrix fibers), may be so high that these form completely the matrix of the composite to be produced, i.e., that a component can be formed in a next producing operation exclusively from the semi-finished product according to the present disclosure, without a matrix-forming material having to be additionally added. The percentage of the thermoplastic fibers in the fiber layer and/or in the nap layer may preferably account for more than 50% and especially more than 70%, so that the subsequent addition of another matrix-forming material during the production of components from the semi-finished products can be eliminated.

The three lower layers (12, 21, 13) of the nap product shown in FIG. 1 form a first, especially preferred embodiment variant of the nap product according to the present disclosure. A fiber layer (21) is accommodated here between two nap layers (12, 13). The exclusive fiber orientation (FA) of the fiber layer (21) is oriented parallel to the identical preferred orientation (VR) of both nap layers (12, 13). The upper and lower nap layers (12, 13) envelope the thread group (23) contained in the fiber layer (21) and support this and protect the threads (24) contained in the thread group (23) from external effects. To achieve this mechanical protective effect, it is advantageous to include at least one fiber layer (21) between two nap layers (12, 13) regardless of how many nap layers and fiber layers are contained in the nap product.

As will be explained farther below, it is, on the other hand, advantageous in terms of production technology to include at least one nap layer (12) between two fiber layers (21, 22) regardless of how many fiber layers are contained in the nap product.

Any desired combination of nap layers (12, 13, 14, 15) with fiber layers (21, 22) is provided within the framework of the present disclosure, and, in particular, the number of such layers as well as the combination of the orientations of preferred orientations and exclusive fiber orientations may be combined as desired in order to obtain advantageous product properties.

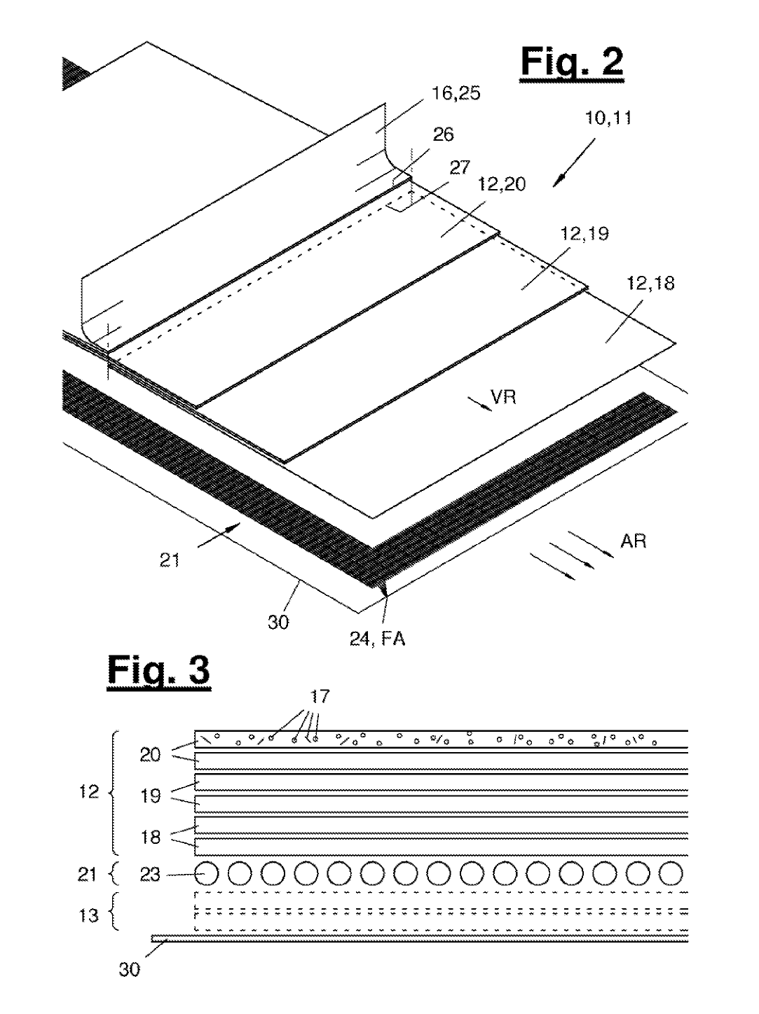

FIG. 2 shows a first embodiment variant for the laying by plaiting of a fiber nap (16) on a conveyor (30). The fiber nap is laid in the example shown on an already laid additional fiber layer (21). As an alternative, the laying by plaiting of the fiber nap may be carried out directly on a conveyor (30) or on an already laid other nap layer.

Due to the form of laying shown in FIG. 2 (longitudinal laying of a fiber nap in loops with scaled arrangement), the preferred orientation (VR) of the fiber nap (16) is oriented parallel to the pull-off direction (AR) of the conveyor (30). This variant of laying is called longitudinal laying. Two or more plaited layers (18, 19, 20) are laid during longitudinal laying in a scaled arrangement one on top of another. This may be carried out especially by a nap layer (42) in the form of a longitudinal layer.

Three plaited layers (18, 19, 20) are each laid in the example according to FIG. 2 one on top of another to form a nap layer (12). The plaited layers (18, 19, 20) are offset here in relation to one another, forming a layer closure between the respective topmost plaited layer and the lowermost plaited layer. In the example according to FIG. 2, each plaited layer is a part of a belt loop, and the front layer edge (26) of the plaited layer just to be applied (without reference number) is laid such that it comes to lie exactly in the vertical direction above the rear layer edge (27) of the first plaited layer (18). Each plaited layer (18, 19, 20) contains a lower fiber nap piece, which is produced during a laying motion directed opposite the pull-off direction (AR), as well as an upper fiber nap piece, which is produced during a laying motion oriented in the same direction as the pull-off direction (AR). The laying motion is preferably generated by a laying carriage of a nap-laying apparatus (42). Instead of a loop laying, surface portion laying may be provided. A surface portion may be formed, for example, by cutting off rectangular panel pieces from the fed fiber nap.

FIG. 3 shows as an example a cross-sectional view through the assembly (11) stacked face to face, which is produced during the laying process according to FIG. 2. The fiber layer (21) contains a thread group (23) formed by numerous individual threads (24). The individual threads are arranged essentially exclusively next to each other in the example according to FIG. 3, so that the additional fiber layer (21) has an especially small thickness.

Two fiber nap pieces, which belong to the first plaited layer (18), as well as two additional fiber nap pieces, which belong to the second and third plaited layers (19, 20), are located above the fiber layer (21). These fiber nap pieces form together a nap layer (12). An additional nap layer (13) may possibly be arranged under the fiber layer (21). This additional nap layer (13) may likewise be laid longitudinally, as is the nap layer (12) shown in FIG. 3. As an alternative, the additional nap layer (13) could be a crosslaid nap layer.

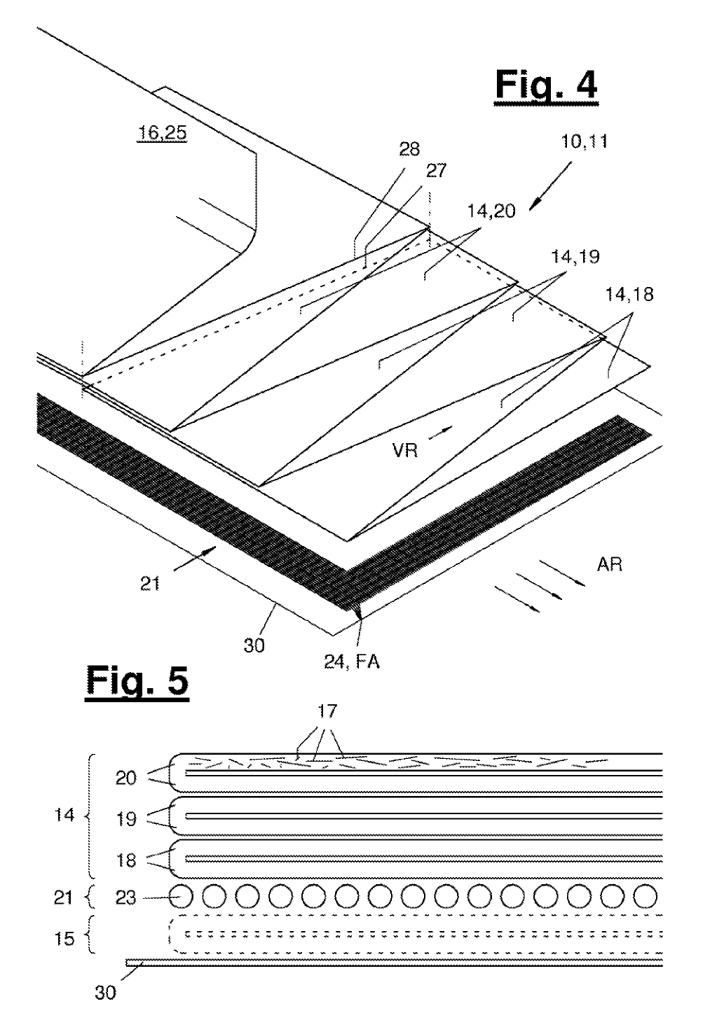

FIG. 4 shows a second embodiment variant for the laying of a fiber nap (14), which is called crosslaying. Two or more plaited layers (18, 19, 20) are laid here at right angles to the pull-off direction (AR) of the conveyor (30) in a scaled arrangement superimposed to one another. The laying may take place in the loop form or in the form of surface portions. While the conveyor (30) is being moved, for example, at a continuous speed in the pull-off direction (AR), the fiber nap (16) is fed at right angles thereto in a to-and-fro motion and laid. This to-and-fro motion is preferably generated by a laying carriage.

Three plaited layers (18, 19, 20) are likewise laid one on top of another at each point in the direction of the panel in the example shown in FIG. 4. Each plaited layer (18, 19, 20) comprises here a first fiber nap piece, which is laid during a forward motion, as well as a second fiber nap piece, which is laid during the opposite backward motion. The to-and-fro motions are always oriented at right angles to the pull-off direction (AR).

A layer closure is preferably also generated between the respective topmost plaited layer to be added anew and the lowermost plaited layer (18). In the example shown in FIG. 4, the front layer edge (26) of the plaited layer just added (without reference number) is positioned such that it comes to lie just above the rear layer edge of the first plaited layer (18).

Since the fiber nap (16) is laid at right angles to the pull-off direction (AR), the preferred orientation (VR), which is generated in the fiber nap (16), for example, by a card (45), may likewise be oriented at right angles to the pull-off direction (AR) in this laying process.

An additional fiber layer (21) is already located under the nap layer (14) just laid in the example shown in FIG. 4 as well. As an alternative, the crosslaying of a fiber nap (16) may be carried out directly to a conveyor (30) or to an already laid other nap layer.

The formation by plaiting of a nap layer (12) by a longitudinal layer or by a crosslayer has the advantage that a nap layer (12), whose thickness is markedly greater and especially equals a multiple of the thickness of the fed fiber nap (16), can be produced with only one nap layer.

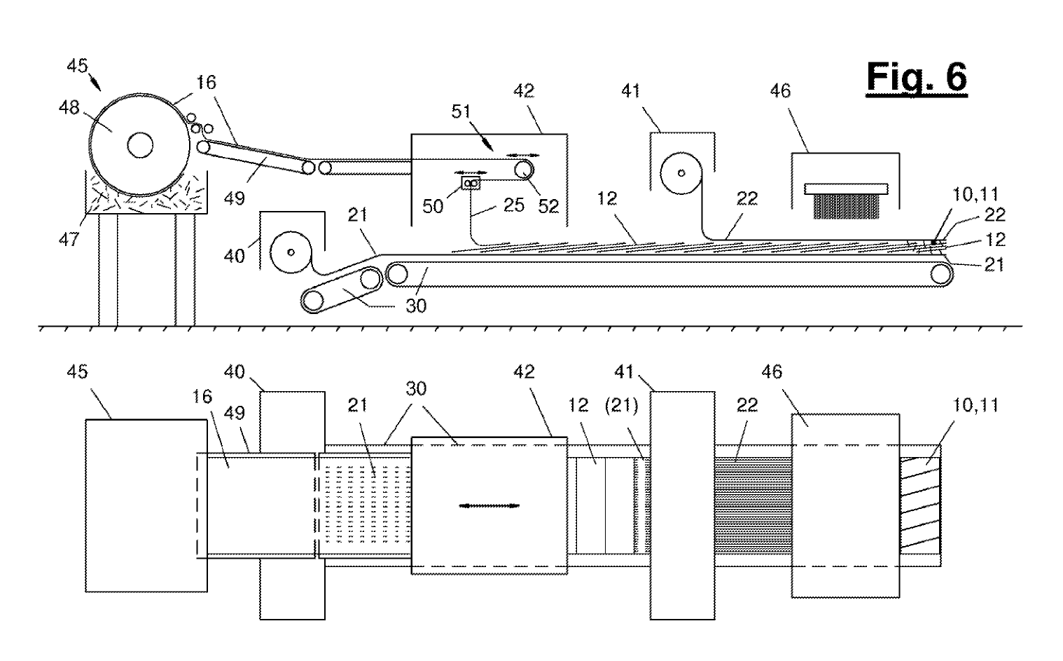

FIG. 5 shows a cross section through the assembly (11) stacked face to face, which is produced in the laying process according to FIG. 4. It differs from the assembly shown in FIG. 4 essentially in that the plaited layers (18, 19, 20) are laid at right angles to the pull-off direction (AR), so that a fold will always come to lie on the outer edge of the nap product (10), which edge is located at right angles to the pull-off direction (AR).

A second nap layer (15) may optionally be provided under the additional fiber layer (21). This may be especially an additional crosslaid nap layer. As an alternative, an additional, longitudinally laid nap layer may be provided.

The laying processes shown in FIGS. 2 and 4 may be combined with one another and with a possibly interposed thread laying as desired. In particular, two or more laying devices (40, 41, 42, 43, 44), which are arranged along the pull-off direction (AR) and which add each different nap layers (12, 13, 14, 15) and fiber layers (231, 22) to an assembly (11) of the nap product (10) according to the present disclosure, which said assembly is stacked face to face, may be arranged at a conveyor (30).

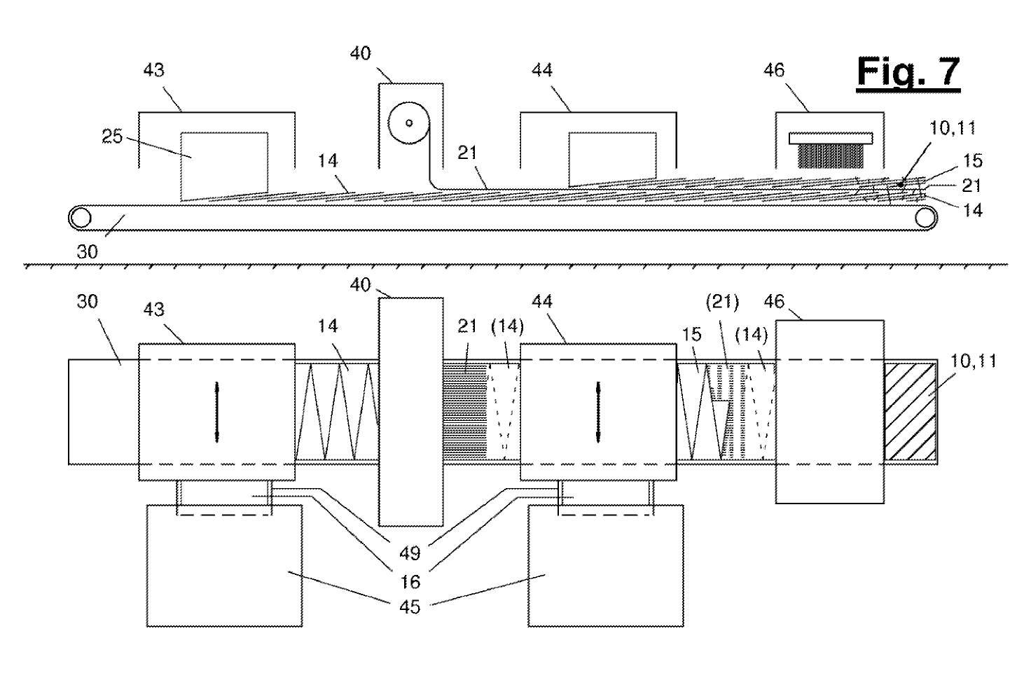

FIGS. 6 and 7 show examples for a production plant for producing a nap product according to the present disclosure.

A common conveyor (30), along the pull-off direction (AR) of which a first thread group layer (40), a nap-laying apparatus (42) in the form of a longitudinal layer, a second thread group layer (41), as well as a strengthening device (46) are arranged, is provided in the example according to FIG. 6. The common conveyor (30) comprises one, two or more conveyor belts, which are arranged in a common run direction (=pull-off direction) and which are preferably driven at a uniform speed, so that the assembly (11) stacked face to face is formed on the common conveyor (30) by the stepwise addition of (panel-shaped) nap layers (12, 13, 14, 15) and fiber layers (21, 22).

A cross-sectional view through the production plant (60) is shown in the upper part of FIG. 6, while the lower half of FIG. 6 shows a top view.

At the beginning of the conveyor (30), a first fiber layer (21) is first laid by a thread group layer (40). This fiber layer (21) forms the lowermost layer of the assembly (11) stacked face to face in the example according to FIG. 6.

The thread group layer (40) may have any desired configuration. It may have, for example, one or more storage rolls with prefabricated yarn threads. A suitable pull-off device can form from the plurality of these yarn threads a thread group and lay these on the conveyor (30). The thread group layer (40) may be, in particular, a weft beam or warp beam or contain a weft beam or warp beam.

As an alternative, the thread group layer may comprise a yarn generator, especially a plurality of filament yarn generators. A filament yarn may optionally be released or laid by a filament yarn generator directly onto the conveyor (30). As an alternative, a pull-off and laying device may be inserted in order to form a thread group (23) from the plurality of filament yarns and to lay these.

The longitudinal layer (42) is arranged following the conveyor (30) in the pull-off direction (AR). The longitudinal layer (42) may have any desired configuration. In the example shown, it comprises a laying carriage (50), which can be moved parallel to the pull-off direction (AR) and by which a free end of a fiber nap (16) fed to the longitudinal layer (42) is laid by a to-and-fro motion. The fiber nap (16) may preferably be fed to the laying carriage (50) via a likewise longitudinally movable deflecting carriage (52). A loop or a belt storage device (51), which is used for speed compensation between the output of the fiber nap at the laying carriage (50) and the preferably continuous feed velocity of the fiber nap (16) to the layer (42), can be formed by the deflecting carriage (52) within the longitudinal layer (42).

The fiber nap (16) is transported via a feed belt (49) to the nap-laying apparatus (42). A nap supply unit (45), which is configured here as a nap-forming device in the form of a card, is arranged in front of the feed belt (49). The production of unstrengthened fiber naps by a card is known in practice. A card has, for example, a large garnished roller, which forms the so-called swift (48). Fibers removed from a flock chamber (47) are carried on the swift (48) and shaped or combed into a flock-like or cotton wad-like nap. The flock-like or cotton wad-like formation is taken off from the swift (48) by a plurality of doffing cylinders and optionally shaped into the fiber nap (16) under gentle compaction.

As an alternative, any other desired form of nap supply unit (45) may be present. For example, a prefabricated fiber nap (16) may be taken off from a roll-type storage device and fed to the nap-laying apparatus (42). As an alternative, a nap-forming device (45) may, in turn, be a vibrating shaft feeder or a feed shaft.

A second thread group layer (41), which may have the same configuration as the aforementioned first thread group layer (40), is arranged behind the nap-laying apparatus (42) along the pull-off direction (AR) of the conveyor (30) in the example according to FIG. 6. A second fiber layer (22) is laid onto the nap layer (12) formed previously by the second thread group layer (41).

A strengthening device (46), which feeds the assembly (11) stacked face to face, may be arranged as an optional element at the end of the conveyor (30). It is a needling machine or a needle mechanism in the example shown in FIG. 6. Such machines are known in practice.

The needling machine comprises a needle bar, which is fitted with a plurality of needles oriented essentially at right angles to the conveyor (30). The needles are inserted into the assembly (11) stacked face to face and are pulled out again by the up and down motion of the needle bar. Each of the needles can now carry one or a few fibers from the different layers (21, 12, 22) and re-orient at least some of the fibers being carried and possibly introduce them into an adjacent layer. Isolated connection points, which lead to a partial strengthening, are created between the adjacent layers (21, 12, 22) by the re-oriented fiber parts.

A thread group layer (40, 41) may possibly be made smaller than a card or a corresponding other nap-forming device (45). It is thus simpler in terms of production technology to provide two or more thread group layers (40, 41) along the pull-off direction (AR) of a (common) conveyor (30) than a plurality of longitudinal layers (42) with associated nap-forming devices (45). The arrangement in series of a first thread group layer (40), of a longitudinal layer (42) and of a second thread group layer (41), which is shown in FIG. 6, represents an especially simple and cost-effective and therefore preferred embodiment variant for a production plant (60) according to the present disclosure.

FIG. 7 shows another advantageous embodiment variant of a production plant (60). A first nap-laying apparatus (43), a thread group layer (40) and a second nap-laying apparatus (44) are arranged here one after another in the pull-off direction (AR) of the conveyor (30). At least the second nap-laying apparatus (44) may preferably be configured as a crosslaying device (also called crosslayer). The fiber nap (16) is fed in case of a crosslayer (44) from a side of the conveyor (30), i.e., at right angles to the pull-off direction (AR), so that the nap supply unit (45) may likewise be arranged on the side next to the conveyor (30). The nap supply unit (45) may have one of the above-mentioned configurations here.

The first nap-laying apparatus (43) is also configured as a crosslayer in the example according to FIG. 7. As an alternative, it could be configured as a longitudinal layer (42), similarly to the view shown in FIG. 6.

A first nap-laying apparatus (14) is laid first in the pull-off direction (AR) of the conveyor (30) in the process shown in FIG. 7. A fiber layer (21) is subsequently formed on this first nap layer by laying a thread group (23) and a second nap layer (15) is then laid on this. The assembly (11) stacked face to face may be fed to a strengthening device (46) in the example according to FIG. 7 as well.

Various variants of the present invention are possible. In particular, the features described, shown or claimed in connection with the individual exemplary embodiments may be combined with one another, replaced with one another, complemented or omitted as desired.

According to a preferred embodiment variant, not shown, a first nap layer configured as a longitudinal layer, a thread group layer, as well as a second nap layer configured as a longitudinal layer may be arranged one after another in the pull-off direction (AR) at a common conveyor (30). The two nap-laying apparatus may each be connected to a respective nap supply unit (45) of their own. As an alternative, two or more nap-laying apparatus may be connected to a common nap supply unit, especially to a common card or to a common vibrating shaft feeder or feed shaft. Two or more fiber naps (16) maybe taken off sequentially, in particular, at the card from a single swift (48) at the card (for different fiber types), and these fiber naps are conveyed to a first nap-laying apparatus, on the one hand, and to a second nap-laying apparatus, on the other hand.

Another embodiment variant, not shown, makes provisions for at least one fiber nap to be able to be wound with at least one carrying strap on a roll. Such a fiber nap may be fed together with the carrying strap on the inlet side of the production plant. An additional fiber layer may be laid in the further course on the wound-off fiber nap. Furthermore, one or more additional nap layers or fiber layers may be stacked on. The assembly stacked face to face may optionally be wound up again together with the carrying strap at the outlet of the production plant or of the conveyor. The nap and/or the assembly stacked face to face may be slightly strengthened in order to increase the ability to be wound up or the suitability for winding. Furthermore, it is possible to form an assembly stacked face to face by applying a fiber layer and optionally another nonwoven layer to a wound-off nonwoven, and a slight strengthening may likewise be carried out, especially by a slight needling.

The above-mentioned process may optionally be carried out as a multistep process one after another, so that, for example, either a single fiber nap or an assembly stacked face to face, which was already formed before, is fed at the inlet of the production plant. An additional fiber layer and optionally another nap layer may then be added within the production plant, and the corresponding expanded assembly stacked face to face can be wound up again at the outlet of the production plant.

The assembly stacked face to face according to the present disclosure is formed preferably free from seams or stitches, which would disturb the homogeneity of the nap product over the surface. In particular, the at least one nap layer and the at least one additional fiber layer are each unsewn and unstitched in themselves as well as between each other. It is achieved due to the absence of additional seams or stitches that the strength properties and the drapability of the assembly stacked face to face result essentially exclusively from the adhesion between the layers as well as from the partial strengthening, if any, of the assembly. Completely homogeneous properties can thus be obtained over the surface of the nap product. In particular, the formation of preferred folds, which are disturbing in prior-art semi-finished products and which are frequently caused there by a cross seam or an additional stitch, can be avoided.

An alternating stacking sequence of a nap layer (12, 13) and an additional fiber layer (21, 22) is preferably provided in the assembly (11) stacked face to face.

The present disclosure comprises as an independent aspect a production process for producing a nap product according to the above description. This process comprises the following steps:
Formation of an assembly (11) stacked face to face from at least one nap layer (12, 13, 14, 15) from a nonwoven fiber nap (16) and at least one additional fiber layer (12, 22) by laying the panel-shaped nap layer (12, 13) on a conveyor (30); and
Stacking on of at least one thread group (23) to form another fiber layer (21, 22) above and/or under the nap layer (12, 14), especially on the same conveyor (30).

The production process preferably comprises, furthermore, the steps:
Partial strengthening of the assembly (11) of the nap product (10), which assembly is stacked face to face, by generating local connection points between the fibers of the different layers (12, 13, 14, 15, 21, 22), especially by thermobonding and/or needling and/or hydroentanglement.

The production process may comprise all the features that are disclosed individually or in combination in connection with the above-described products and plants.

While specific embodiments of the invention have been shown and described in detail to illustrate the application of the principles of the invention, it will be understood that the invention may be embodied otherwise without departing from such principles.

1. A panel-shaped semi-finished product for producing fiber-reinforced composites, the semi-finished product comprising a partly strengthened assembly of at least one nap layer made of a non-woven fiber nap and at least one additional panel-shaped fiber layer, which at least one nap layer and at least one additional panel-shaped fiber layer, of said assembly are stacked face to face, wherein:
the at least one nap layer and/or the at least one additional fiber layer are formed predominantly or completely from carbon fibers, aramid fibers or mineral fibers;
the fibers contained in the nap layer have a preferred orientation;
the face to face stacking of the assembly is formed exclusively by layering;
the at least one nap layer and the at least one fiber layer are free from additional macro support elements;
the additional fiber layer is stacked onto the at least one nap layer and is formed by a panel-shaped thread group from individual threads arranged next to each other;
the thread group has an exclusive fiber orientation; and
the nap product is partly strengthened by local connection points between the fibers of the different layers.

2. A semi-finished product in accordance with claim 1, wherein the exclusive fiber orientation, in the at least one additional fiber layer, is essentially parallel to the preferred orientation of the at least one nap layer.

3. A semi-finished product in accordance with claim 1, wherein the exclusive fiber orientation in the at least one additional fiber layer is essentially at right angles to the preferred orientation of at least one nap layer.

4. A semi-finished product in accordance with claim 1, wherein:
the at least one nap layer comprises the a first nap layer and an additional nap layer;
the exclusive fiber orientation, in the at least one additional fiber layer, is essentially parallel to the preferred orientation of the first nap layer; and
the exclusive fiber orientation in the at least one additional fiber layer is essentially at right angles to the preferred orientation of additional nap layer.

5. A semi-finished product in accordance with claim 1, wherein the thread group comprises yarn threads from a staple fiber yarn or core yarn, which contains recycled carbon fibers.

6. A semi-finished product in accordance with claim 1, wherein the thread group comprises monofilaments; from a filament yarn.

7. A semi-finished product in accordance with claim 1, wherein the at least one nap layer and/or the at least one additional fiber layer are formed at least partly from a fiber that acts as a matrix-forming component in the composite to be produced from a meltable plastic.

8. A semi-finished product in accordance with claim 1, wherein a nap layer is plaited in itself in two or more layers, with a scaled arrangement of the plaited layers.

9. A semi-finished product in accordance with claim 1, wherein local connection points are formed by: a local entanglement of individual fibers of the different layers of the nap product; and/or
bonding points between individual fibers of the different layers.

10. A semi-finished product in accordance with claim 1, wherein:
the at least one nap layer comprises two nap layers;
a fiber layer of the at least one additional fiber layer is taken up between the two nap layers.

11. A semi-finished product in accordance with claim 1, wherein a nap layer of the at least one nap layer is taken up between two fiber layers of the at least one additional fiber layer.

12. A semi-finished product in accordance with claim 1, wherein the at least one nap layer is formed from two nap layers and the at least one additional fiber layer is formed from one fiber layer,
wherein the preferred orientations of both nap layers are parallel to the fiber orientation of the thread group in the fiber layer, OR
wherein the preferred orientations (VR′) of both nap layers (14, 15) are at right angles to the fiber orientation of the thread group in the fiber layer,
and wherein the fiber layer is taken up between the two nap layers.

13. A semi-finished product in accordance with claim 1, wherein the at least one additional fiber layer is formed from two fiber layers and the at least one nap layer is one nap layer,
wherein the preferred orientation of the nap layer is parallel to the common fiber orientation of the thread groups in the fiber layers, OR
wherein the preferred orientation of the nap layer (14) is at right angles to the common fiber orientation of the thread groups in the fiber layers,
and wherein especially the nap layer is taken up between the fiber layers.

14. A production plant for producing a panel-shaped semi-finished product, comprising a partly strengthened assembly of at least one nap layer made of a non-woven fiber nap and at least one additional panel-shaped fiber layer, which at least one nap layer and at least one additional panel-shaped fiber layer, of said assembly are stacked face to face, wherein: the at least one nap layer and/or the at least one additional fiber layer are formed predominantly or completely from carbon fibers, aramid fibers or mineral fibers; the fibers contained in the nap layer have a preferred orientation; the face to face stacking of the assembly is formed exclusively by layering; the at least one nap layer and the at least one fiber layer are free from additional macro support elements; the additional fiber layer is stacked onto the at least one nap layer and is formed by a panel-shaped thread group from individual threads arranged next to each other; the thread group has an exclusive fiber orientation; and the nap product is partly strengthened by local connection points between the fibers of the different layers, the production plant comprising:
at least one conveyor;
a nap laying apparatus for laying a panel-shaped fiber nap on the at least one conveyor to form the at least one nap layer in the assembly of the semi-finished product;
at least one thread group laying apparatus configured to stack to the nap layer the panel-shaped thread group from individual threads arranged next to each other with the exclusive fiber orientation by laying the thread group on the conveyor; and
a strengthening device, to which the assembly is fed, and which is configured to generate local connection points between the fibers of the different layers, so that the semi-finished product is partly strengthened.

15. A production plant in accordance with claim 14, wherein the conveyor has a pull-off direction and the exclusive fiber orientation of the panel-shaped thread group is parallel to the pull-off direction.

16. A production plant in accordance with claim 14, wherein the conveyor has a pull-off direction and the laying direction of the nap laying apparatus is parallel or essentially at right angles to the pull-off direction.

17. A production plant in accordance with claim 14, further comprising at least one additional nap laying apparatus.

18. A production plant in accordance with claim 14, further comprising at least one additional thread group laying apparatus.

19. A production process for producing a semi-finished product comprising a partly strengthened assembly of at least one nap layer made of a non-woven fiber nap and at least one additional panel-shaped fiber layer, which at least one nap layer and at least one additional panel-shaped fiber layer, of said assembly are stacked face to face, wherein: the at least one nap layer and/or the at least one additional fiber layer are formed predominantly or completely from carbon fibers, aramid fibers or mineral fibers; the fibers contained in the nap layer have a preferred orientation; the face to face stacking of the assembly is formed exclusively by layering; the at least one nap layer and the at least one fiber layer are free from additional macro support elements; the additional fiber layer is stacked onto the at least one nap layer and is formed by a panel-shaped thread group from individual threads arranged next to each other; the thread group has an exclusive fiber orientation; and the nap product is partly strengthened by local connection points between the fibers of the different layers, the production process comprising the steps of:
forming the assembly of the at least one nap layer from a non-woven fiber nap and the at least one fiber layer stacked to the at least one nap layer face to face, wherein the at least one nap layer and/or the at least one additional fiber layer are formed predominantly or completely from carbon fibers, aramid fibers or mineral fibers, and the fibers contained in the nap layer have the preferred orientation wherein the assembly stacked face to face is formed exclusively by layering, wherein the at least one nap layer and the at least one fiber layer are free from additional macro support elements;
forming the at least one additional fiber layer by laying a web-shaped thread group from individual threads arranged next to each other with the exclusive fiber orientation; and
partially strengthening the stacked assembly by generating local connection points between the fibers of the different layers.
